(19) United States
(12) Patent Application Publication
(10) Pub. No.: US 2012/0150915 A1
(43) Pub. Date: Jun. 14, 2012

(54) DIGITAL FORENSIC APPARATUS FOR ANALYZING USER ACTIVITIES AND METHOD THEREOF

(75) Inventors: Woo Yong Choi, Daejeon (KR); Sung Kyong Un, Daejeon (KR); Do Won Hong, Daejeon (KR); Sang Jin Lee, Seoul (KR); Je Wan Bang, Seoul (KR); Jung Heum Park, Seoul (KR); Nam Heun Son, Seoul (KR)

(73) Assignees: Korea University Research And Business Foundation, Seoul (KR); Electronics and Telecommunications Research Institute, Daejeon (KR)

(21) Appl. No.: 13/324,683

(22) Filed: Dec. 13, 2011

(30) Foreign Application Priority Data
Dec. 13, 2010 (KR) 10-2010-0127132

(51) Int. Cl. G06F 7/00

(52) U.S. Cl. 707/802; 707/E17.01; 707/E17.044

(57) ABSTRACT

A digital forensic apparatus for analyzing user activities includes: a collection unit for collecting analysis information related to user activities from a device as an investigation target for analyzing the user activities; and an analysis unit for analyzing the analysis information collected by the collection unit to determine activity information of a user from each type of the analysis information, and for causing the activity information to be arranged and displayed in temporal order.

### CROSS-REFERENCE(S) TO RELATED APPLICATION(S)

The present invention claims priority of Korean Patent Application No. 10-2010-0127132, filed on Dec. 13, 2010, which is incorporated herein by reference.

### FIELD OF THE INVENTION

The present invention relates to a digital investigation method which is performed in a user system and, more specifically, to a digital forensic apparatus for analyzing user activities and a method thereof, which collect data useful for the analysis of user activities and display the collected data in temporal order, thereby allowing a digital forensic investigation to be carried out more rapidly and efficiently.

### BACKGROUND OF THE INVENTION

In general, digital forensics refers to a technology that collects and analyzes digital evidence. The digital forensics encompasses all the procedures of collecting, preserving, analyzing and documenting evidence and presenting the evidence to a court.

Recently, more than about 95% of a total amount of information that is produced and distributed is digital information. Due to the development of digital technology, evidence of crimes exists in a variety of locations such as networks, the Internet, databases and mobile devices. Portable personal digital devices, such as a mobile phone, a personal digital assistant (PDA), an electronic pocket diary, a digital camera, an MP3 player, a camcorder, or a portable memory card, are easily used to hide evidence of a crime because they are small and easy to carry. Thus, when there is a need to secure evidence, it is very important to acquire necessary information from such personal digital devices, analyze the information, and secure the evidence of a crime.

In such digital forensic investigation, when an analysis is performed on a computer as a target, a variety of types of information may be used, and a variety of tools are also used to obtain such information.

Although most conventional digital forensic tools can obtain a variety of types of information, the obtained information is a simple collection of raw data. Accordingly, the collected information needs to be processed one or more times in order to become meaningful data. Furthermore, if a search warrant which is issued in a digital forensic investigation does not support an entire disk imaging but allows only the collection of specific files and if a length of time given for the investigation is short, there occurs a problem that time required for obtaining and processing information by using various tools cannot be acquired.

### SUMMARY OF THE INVENTION

In view of the above, the present invention provides a digital forensic apparatus and method for analyzing user activities, which, in order to enable an investigator to determine user activities conducted on various computing systems, such as computers, at respective specific times, collect and process data to be used in the analysis of user activities, automatically analyze the collected data, and then display the collected data in temporal order, thereby allowing a digital forensic investigation to be carried out more rapidly and efficiently.

In accordance with an aspect of the present invention, there is provided a digital forensic apparatus for analyzing user activities, including:

a collection unit for collecting analysis information related to user activities from a device as an investigation target for analyzing the user activities; and

an analysis unit for analyzing the analysis information collected by the collection unit to determine activity information of a user from each type of the analysis information, and for causing the activity information to be arranged and displayed in temporal order.

In accordance with another aspect of the present invention, there is provided a digital forensic method for analyzing user activities, including:

collecting analysis information related to user activities from a device as an investigation target for analyzing the user activities;

analyzing the collected analysis information to determine activity information of a user from each type of the analysis information; and

causing the activity information to be arranged and displayed in temporal order.

### BRIEF DESCRIPTIONS OF THE DRAWINGS

The objects and features of the present invention will become apparent from the following description of embodiments, given in conjunction with the accompanying drawings, in which:

FIG. 1 is a detailed block diagram of a digital forensic apparatus in accordance with an embodiment of the present invention;

FIG. 2 is a diagram illustrating examples of analysis information and activity information in accordance with an embodiment of the present invention; and

FIG. 3 is a flowchart illustrating the forensic investigation process of determining user activities using the digital forensic apparatus in accordance with an embodiment of the present invention.

### DETAILED DESCRIPTION OF THE PREFERRED EMBODIMENTS

Hereinafter, embodiments of the present invention will be described with reference to the accompanying drawings which form a part hereof.

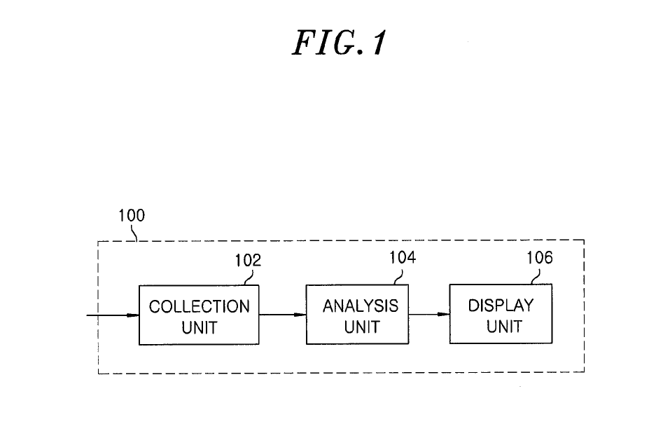

FIG. 1 is a block diagram of a digital forensic apparatus in accordance with an embodiment of the present invention.

Referring to FIG. 1, the digital forensic apparatus 100 includes a collection unit 102, an analysis unit 104 and a display 106.

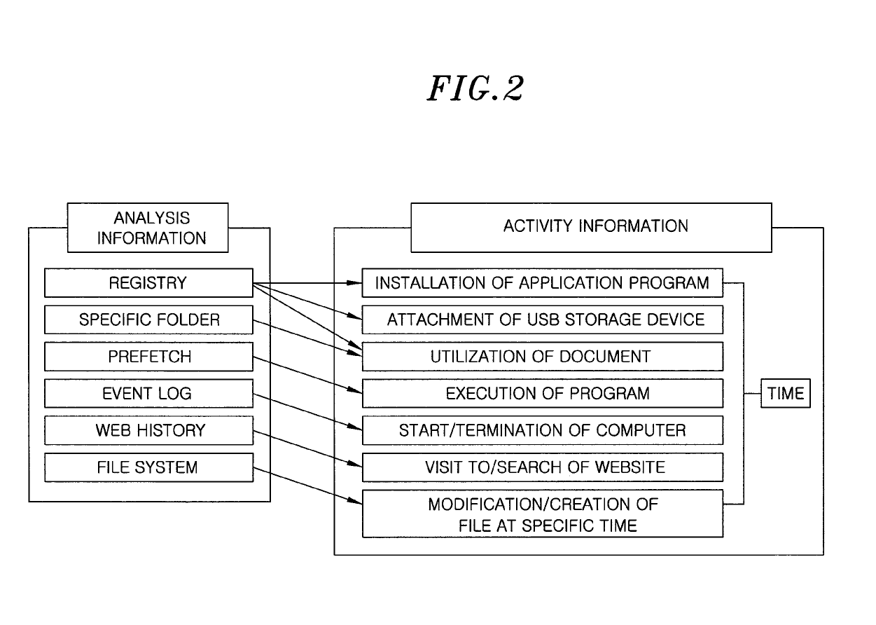

The collection unit 102 collects information related to user activities from a computer system and the like as an investigation target for analyzing the user activities. Such collected information may be classified into analysis information and activity information, as shown in FIG. 2.

The analysis information is information which has been stored in the computer system based on the user activities, and includes, for example, registry, specific folder, prefetch, event log, web history, web browser, memory, file system and other log file information.

The activity information indicates one or more specific activities of a user which are represented by respective pieces of system information included in the analysis information. For example, user activities, such as the installation of application programs, the attachment of universal serial bus (USB) storage devices and the utilization of documents, may be derived from the registry information of the analysis information.

Furthermore, user activities such as the utilization of documents may be derived from the specific folder information, user activities such as the execution of programs may be derived from the prefetch information, and also user activities such as the start and termination of a computer may be derived from the event log information. Furthermore, user activities such as visits to and searches of websites may be derived from the web history information, and user activities such as the modification and creation of files at specific times may be derived from the file system information.

The process of deriving user activities from each item of the analysis information will now be described in detail.

First, the registry is a hierarchical tree-structure database that contains configuration information related to a user account and the hardware and software of a computer. Since a registry contains information that is created by user activities such as the attachment of a USB drive or the installation of an application program, it is worthy of a digital forensic investigation. Here, the registry needs to be appropriately processed when analyzed, based on the consideration that only the last write time is recorded and that a coordinated universal time (UTC) is used to record the last write time.

A USB storage device may be a threat to the security of a company-based system. Recently, a storage capability of the USB storage device has increased while the size thereof has decreased, and accordingly, such a USB storage device can store larger amounts of document material and presentation material. Furthermore, when a system is infected with malicious code, a medium or a route of infection can be determined by identifying the unique instance value of the USB storage device. Information within the USB storage device and the time when the USB storage was attached may be used as important material for the analysis of user activities.

The attachment time of the USB storage device exists in a system file of the registry and the information within the USB storage device that was attached after booting can be obtained based on the last write time by using a key value corresponding to the USB storage device.

The execution path and executable file of an application program are stored at a key under HKEY_LOCAL_MACHINE\SOFTWARE\Microsoft\Windows\CurrentVersion \App Paths of a registry when the application program is installed. A list of application programs that have been installed on a system can be obtained using values of corresponding keys.

All application programs installed in a system and execution paths of executable files can be obtained by examining all the lower keys of App Paths, and the time when application programs were installed can be identified by using the last write time of each key. Furthermore, by using such information, a list of the application programs can be constructed on a basis of the time when the application programs were installed. If an application program had been installed at a specific time but does not exist upon examination, it is presumed that the application program was deleted after used. In particular, if the application program was deleted after an anti-forensic tool has been used, it is presumed that an intentional malicious activity was conducted.

The prefetch that has been provided in versions released after Windows XP is directed to a technology that loads data necessary for the running of an application program onto memory in advance to improve the speed of execution of the application program.

By using prefetch information, the latest execution time of the latest executed file, an execution path, and the number of times of execution can be acquired. When the entire path to an executable file is known, MAC (Modified, Accessed, and Created) time of the executable file can be found out. The created time of the executable file indicates when it was created. The execution time and created time of files may be used to analyze activities that have occurred at specific times.

A folder “%windir%\prefetch” includes a file named in a form of [filename]-[HASH].pf, which contains the total number of times that an application program has been executed, the last execution time, and referenced library information. An execution time of a Windows system can be found out by using execution time of WMIPRVSE.EXE and WUAUCLT.EXE that are automatically run when Windows runs, since the execution time of the two files is consistent with the execution time of the Windows system.

Useful information among the event log for the analysis of user activities includes the time when a user starts to use a computer and the time when the user stops using the computer. Such information may be used as reference points for the analysis of user activities.

Windows records logs related to system warnings, failure reports and audit policies in the event log. A Windows system records three types of logs, that is, application program logs, security logs and system logs, as events.

The purpose for which most users use a personal computer (PC) is to surf the Internet using a web browser. Therefore, the details of the use of a web browser are also important in forensic investigation. In order to ensure high speed, most currently existing web browsers create a variety of information files, such as cache files, cookie files, visitation records and downloaded files, and store them within systems on which the web browsers were installed.

Meanwhile, the function of providing information about recently used documents has been provided in versions released after Windows XP. Methods of obtaining information about recently used documents may be classified into two types.

The first type is a method using a most recently used (MRU) key value. An XP-based registry address is HKEY_CURRENT_USER\Software\Microsoft\Windows\CurrentVersion\Explorer\ComDlg32\OpenSaveMRU. Information can be obtained for each extension of used document files using the above key value.

The second type is a method using the link file of a %USERPROFILE%\Recent folder.

User activities can be determined based on information about recently used document files, which is obtained by using the above two methods. In particular, frequently used document files, such as Hangeul or MS Word files, may be important materials. The time when each document file was last modified can be found out, and the flow of the details of documentary work can be determined. Furthermore, when a specific file exists in the details of recent documents but the file does not actually exist, it is presumed that the file was moved to a USB storage device or deleted after worked, and therefore the above facts may be used as useful information for a forensic investigation.

The analysis unit 104 analyzes information which is collected from the computer system as the investigation target by using a variety of tools by the collection unit 102 when a forensic investigation is performed. Further, the analysis unit 104 determines user activity information from each type of the analyzed information. Thereafter, the analysis unit 104 causes the determined user activity information to be displayed on the display unit 106, so that an investigator can more efficiently and rapidly perform investigation using visually represented materials.

Here, the analysis unit 104 may enable the user activity information to be enumerated on the display unit 106 in temporal order. When the user activity information is enumerated in temporal order, it is possible to presume the flow of events. Furthermore, when the user activity information is not only enumerated but also visually displayed on the display unit 106, the activities conducted by the user can be easily revealed at a glance.

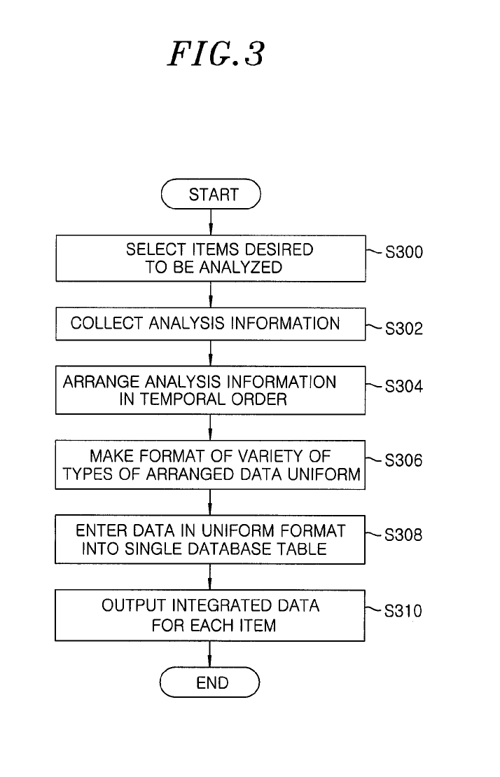

FIG. 3 is a flowchart illustrating the process of determining user activities using the digital forensic apparatus 100 shown in FIG. 1. This embodiment of the present invention will be described in detail below with reference to FIGS. 1 to 3.

First, at step S300, an investigator selects items desired to be collected by the collection unit 102, with respect to a computer system as an investigation target for determining user activities.

Then, at step S302, the collection unit 102 recognizes the analysis items selected by the investigator, and collects analysis information of the items selected by the investigator from a variety of information stored within the computer system in connection with user activities.

Here, the analysis information may include registry, specific folder, prefetch, event log, web history and file system information, as described above. The collected analysis information is delivered to the analysis unit 104.

Then, the analysis unit 104 arranges the analysis information, collected by the collection unit 102, in temporal order at step S304, and determines user activity information corresponding to each item of the analysis information and then makes the format of a variety of types of the user activity information uniform at step S306.

Next, the analysis unit 104 enters data in the uniform format into a single database table at step S308, and causes integrated data for each item to be displayed on the display unit 106 in temporal order at step S310, so that the investigator can more easily recognize user activities on the computer system.

As described above, the present invention is configured to, in order to enable an investigator to recognize user activities conducted at respective specific times on various computing systems, collect desired data to be used in the analysis of user activities, automatically analyze the collected data, and then display the analyzed data in temporal order, thereby providing the advantage of allowing a digital forensic investigation to be carried out more rapidly and efficiently.

Further, the present invention is configured to visualize user activities, conducted on a specific system, in temporal order, thereby providing the advantage of allowing an investigator to easily recognize activities at respective specific times in detail, and is configured to perform analysis using a single tool rather than a variety of tools, thereby providing the advantage of considerably reducing time taken to carry out an investigation. While the invention has been shown and described with respect to the embodiments, it will be understood by those skilled in the art that various changes and modification may be made without departing from the scope of the invention as defined in the following claims.

What is claimed is:

1. A digital forensic apparatus for analyzing user activities, comprising:
a collection unit for collecting analysis information related to user activities from a device as an investigation target for analyzing the user activities; and
an analysis unit for analyzing the analysis information collected by the collection unit to determine activity information of a user from each type of the analysis information, and for causing the activity information to be arranged and displayed in temporal order.

2. The digital forensic apparatus of claim 1, wherein the collection unit receives one or more analysis items selected by an investigator, and collects the analysis information of the received items from the device.

3. The digital forensic apparatus of claim 1, wherein the analysis unit makes a format of the activity information uniform, and enters the activity information in a uniform format into a database table.

4. The digital forensic apparatus of claim 1, wherein the analysis information includes at least one of registry information, specific folder information, prefetch information, event log information, web history information and file system information.

5. The digital forensic apparatus of claim 4, wherein the analysis unit, when receiving the registry information among the analysis information, determines the activity information such as attachment of a universal serial bus (USB) drive or an installation of an application program by analyzing the registry information.

6. The digital forensic apparatus of claim 5, wherein the analysis unit obtains information about recently used documents on the device by using a most recently used key value of the registry information, thereby determining the activity information of the user.

7. The digital forensic apparatus of claim 1, wherein the activity information includes at least one of information about installation of application programs, attachment of USB storage devices, utilization of documents, execution of programs, visits to and searches of websites and modification and creation of files at specific times.

8. A digital forensic method for analyzing user activities, comprising:
collecting analysis information related to user activities from a device as an investigation target for analyzing the user activities;
analyzing the collected analysis information to determine activity information of a user from each type of the analysis information; and
causing the activity information to be arranged and displayed in temporal order.

9. The digital forensic method of claim 8, wherein said collecting the analysis information includes:
receiving one or more analysis items selected by an investigator with respect to the device as the investigation target; and
collecting the analysis information of the received items from the device.

10. The digital forensic method of claim 8, wherein a format of the activity information is made uniform, and the activity information in a uniform format is entered into a database table.

11. The digital forensic method of claim 8, wherein the analysis information includes at least one of registry information, specific folder information, prefetch information, event log information, web history information and file system information.

12. The digital forensic method of claim 8, wherein the activity information includes at least one of information about installation of application programs, attachment of USB storage devices, utilization of documents, execution of programs, visits to and searches of websites and modification and creation of files at specific times.

13. The digital forensic method of claim 11, wherein when the registry information is received, the activity information such as attachment of a universal serial bus (USB) drive or an installation of an application program is determined by analyzing the registry information.

14. The digital forensic method of claim 13, wherein information about recently used documents on the device is obtained by using a most recently used key value of the registry information to thereby determine the activity information of the user.
